(19) United States
(12) Patent Application Publication
(10) Pub. No.: US 2024/0174567 A1
(43) Pub. Date: May 30, 2024

(54) BINDER FOR BUILDING MATERIALS, METHOD FOR PRODUCTION THEREOF AND PLANT FOR CARRYING OUT THIS METHOD

(71) Applicants: Heidemann Recycling GmbH, Stade (DE); EEW Energy from Waste GmbH, Helmstedt (DE)

(72) Inventors: Alf Heidemann, Stade (DE); Joern Richter, Stade (DE); Michael Larisch, Helmstedt (DE); Morten Holpert, Helmstedt (DE); Georg Bachmann, Oldendorf (DE)

(21) Appl. No.: 18/285,095

(22) PCT Filed: Mar. 28, 2022
(86) PCT No.: PCT/DE2022/100231

§ 371 Date: Sep. 29, 2023

(30) Foreign Application Priority Data
Apr. 1, 2021 (DE) 10 2021 108 322.2

(51) Int. Cl. C04B 18/10; B03B 9/04; C04B 28/08

(52) U.S. Cl. CPC C04B 18/10; B03B 9/04; C04B 28/082

(57) ABSTRACT

A binder for building materials comprising cement and mineral grinding additives, said grinding additives containing ash of burned refuse. Relative to the binder, the ash of burned refuse has a weight percent of 0.005 to 0.4 and a Blaine specific surface area of 1500 cm²/g to 6000 cm²/g. Also, a process and to a plant for carrying out the process for production of a binder for building materials comprising cement and mineral grinding additives, the grinding additives containing ash of burned refuse, the process including: preparing the ash of burned refuse provided as grinding additive by separating out the fraction having a particle size less than 1 mm and the oversize particles having a particle size greater than 40 mm; pre-crushing the ash of burned refuse which has been freed from the undersize particles and the oversize particles; removing ferrous and non-ferrous metals; further crushing of the pre-crushed ash of burned refuse which has been substantially freed from metals, in order to achieve a Blaine specific surface area from 1500 cm²/g to 6000 cm²/g, adding the ash of burned refuse prepared in this way to the cement before and/or after the further crushing of the ash of burned refuse which has been pre-crushed and substantially freed from metals.

The invention relates to a binder for building materials comprising cement and mineral additives, the additives containing waste incineration ash. The invention also relates to a process for producing such a binder and a plant for carrying out this production process.

Cement or a binder containing cement is a hydraulically hardening building material comprising a finely divided mixture of non-metallic and inorganic components. Cement can be produced by jointly grinding a Portland cement clinker burned during sintering in a rotary kiln with other main and secondary components or by mixing separately finely ground main and secondary components and adding a setting regulator such as gypsum and/or anhydrite. Cement is mainly used as a binder for mortar and concrete. When fresh, after the addition of water, cement hardens both in air and under water. In the fresh state there is any formability of the mixture with sand and coarser rock grains laid out with a certain grain size distribution. In the hardened state, the cement stone connects this grain structure. The main properties of cement, such as the timing of setting and hardening, strength properties and chemical and physical resistance are known to depend on the chemical and mineralogical composition of the raw materials, the ash from the fuels used in the sintering process in the rotary kiln, the proportion of the ground or mixed main and secondary components and the optimal matching of the setting regulator used, such as gypsum and/or anhydrite.

Furthermore, the fineness of grinding and the grain size distribution of its main components are decisive for the most important properties of the cement or cement-containing binder produced in this way. According to DIN EN 196-6, the grinding fineness can be described by the mass-related Blaine surface area using air permeability measurements in cm²/g. Cements with a grinding fineness of less than 2800 cm²/g are considered coarse, those with more than 4000 cm²/g are fine. Cements with a Blaine value of 2800-4000 cm²/g have a medium fineness, while very fine cements are between 5000 cm²/g and 7000 cm²/g. All standardized types of cement and their composition are listed according to DIN EN 197-1. The types of cement most commonly used in the cement industry are Portland cement, Portland slag cement and blast furnace cement. According to the standard, Portland cement has the abbreviation CEM I. With Portland cement, it is known to replace part of the Portland cement clinker with blast furnace slag. In the production of pig iron from the gangue of the ore, coke ash and aggregates, blast furnace slag is a by-product, initially as blast furnace slag. Rapid cooling of the liquid slag with water to temperatures <100° C. produces glassy solidified blast furnace slag with grain sizes of up to a few mm. Granulated blast furnace slag is a latently hydraulic substance that hardens hydraulically like cement in a technically usable time using an activator such as Ca(OH)₂, CaSO₄ etc.

In the conventional cements containing blastfurnace slag, the blastfurnace slag is usually ground to a Blaine fineness of 3500 to 4500 cm²/g. However, higher grinding finenesses of up to more than 6000 cm²/g but also grinding Blaine finenesses of 1600 cm²/g to 2500 cm²/g are known, with the coarser variant also being referred to as blast furnace slag. Such a Portland cement containing blastfurnace slag is also referred to as Portland slag cement and according to the standard has the abbreviation CEM II. With a blastfurnace slag content of 6 to 20%, an A is added to the abbreviation and with a proportion of 21 to 35% the letter B is added. Blast furnace cements can have a blast furnace slag content of 36 to 95% and have the abbreviation CEM III according to the standard. Here, too, the letters A, B or C are added depending on the blast furnace slag content. It is also common to characterize a cement by its strength class, such as 32.5, 42.5 and 52.5. If a cement has a high early strength, it is also given the abbreviation R. If it has a normal early strength, it is also given the abbreviation N.

In terms of process engineering, Portland slag cements and blast furnace cements can basically be produced both by grinding the main components together and by mixing finely divided main components that are added separately.

Waste incineration bottom ash (slag) accumulates, in addition to filter dust and salts, during the thermal utilization of waste from waste incineration plants. After incineration, they are discharged from the combustion chamber via a slag remover, usually a wet slag remover. Slag mainly consists of non-combustible minerals, metals, salts, sulphates and a small proportion of unburned matter. They also contain no inconsiderable amounts of heavy metals and other trace elements, which make it difficult to use them economically without further processing. Therefore, slag or ashes are usually further processed for further use, whereby ferrous and non-ferrous metals as well as unburned material are separated. The mineral fraction can be treated accordingly by sieving, air classification, magnetic separation, eddy current separation, crushing and aging after dry processing or by wet processing through hydraulic separation of salts and sand separation.

According to the draft of an ordinance for the introduction of an ordinance for substitute building material, for the revision of the Federal Soil Protection and Contaminated Sites Ordinance and for the amendment of the Landfill Ordinance and the Commercial Waste Ordinance of Nov. 6, 2020 published by the Federal Ministry for the Environment, Nature Conservation, Nuclear Safety and Consumer Protection § 2 No. 28, household waste incineration ash is classified as “Prepared and aged bottom ash and boiler ash from plants incinerating household waste and similar commercial and industrial waste, as well as waste from private and public facilities”. Correspondingly, the term incineration bottom ash (abbreviated: IBA) is used in the present application; the term incineration bottom ash is also often used synonymously in other sources. The household waste incineration bottom ash (HIBA) or synonymously household waste incineration slag (HWIS) is processed bottom ash or grate waste that is produced during the incineration of household waste/municipal waste in waste incineration plants in the combustion chamber of waste incineration plants. This thermal treatment generates energy and reduces the amount of household waste by 75%. This waste incineration ash or synonymous slag is a powdery material with dimensions from 0 mm to over 500 mm. A distinction must be made between waste incineration ash or slag and the filter dust and fly ash that also occurs elsewhere in waste incineration, namely at the flue pipes and filters. For example, between 5 and 6 million tons of household waste incineration ash (household waste incineration slag) are produced in Germany every year. Processed household waste incineration bottom ash is one of the substitute building materials and is subject to the relevant structural and environmental regulations for the relevant areas of application.

Waste incineration bottom ash is not yet a permitted main or secondary component in cements standardized according to DIN EN 197-1 due to the numerous ingredients that are harmful to the cement, since when used with cement in concrete they lead to undesirable reactions such as cracking, flaking, and leaching of heavy metals on contact with atmospheric agents such as water, nitrous acids, ammonia, carbon dioxide, etc. Processes for immobilizing pollutants from slag, ash and filter dust from waste incineration plants or from other industrial plants by using inorganic, hydraulically active binders based on cement are listed in numerous patents and published documents.

It is known from DE 36 41 786 A1 that adding inorganic and/or organic binders to slag and/or filter dust from incineration ashes and optionally adding the amount of water required to bring about a mortar-like consistency produces a mixture which, after drying, has a rock-hard mass, the tightness of which can be controlled by the proportions of the mixture components depending on the intended use. The admixtures of a hydraulic binder to the slag are between 5-35%, the proportion of slag between 65-95%. The hardened mass can be broken up into heaps and dumped. However, it can also be used as blow backfill underground or as a frost-proof filling in road construction. There is no reference to fine-particle processing of the incinerator bottom ash in the published application.

DE 10 2004 051 673 A1 describes a process for producing a landfill binder for immobilizing waste containing heavy metals at a landfill, wherein as landfill binders various ashes, residues and waste products containing pollutants are primarily used. The immobilization of soluble heavy metal compounds from waste is possible and can be carried out in a leach-proof manner through controlled chemical/adsorptive binding to certain mineral phases such as ettringite. Components from the cement industry rich in free lime, such as bypass or fine flour, are used as residues. The landfill binder does not need to add pure cement.

EP 0 934 906 B1 describes a process for improving the transportability, workability and incorporability of a sludge by changing its consistency, in which a calcareous power plant filter ash is added as an additive with a proportion of between 2 and 7% by weight based on the dry mass of the sludge. However, no statement is made about the hydraulic setting of the mixture and a permanent immobilization of pollutants.

DE 196 12 513 A1 describes a binder for immobilizing pollutants in and/or for solidifying soils, soil-like mixtures, sludges, production and other residues, which contains blast furnace meal and fly ash. The blast furnace meal can be material that is also used as a component of commercial blast furnace cements. It is preferably ground blast furnace slag and/or ground slag sand. The fly ash can come from hard coal and/or brown coal power plants or from fluidized bed furnaces. The binder serves to bind pollutants by hardening the test bodies. The mechanical strengths that can be achieved are comparable to concrete. The swelling capacity of the fly ash used is absorbed by the use of blast furnace meal. There is no detailed reference to the production and necessary fineness of the incineration bottom ash, e.g. a specifically comparable surface or fineness such as blast furnace slag powder or fly ash, in order to prevent damaging reactions such as swelling, cracking in the shaped bodies in the hardened concrete in advance due to faster reaction processes in the fresh concrete. The proportion of ash in the formulations is consistently very high.

Furthermore, DE 10 2017 114 831 A1 discloses a process for processing fly ash by grinding fly ash with a dry-operated agitator ball mill. This refining mechanically activates the fly ash, resulting in an improved fly ash quality that allows Portland pozzolan cements to be made into binders that can even meet cement standards. Furthermore, a plant for the production of cement with at least one first grinding stage consisting of a first mill and a first classifier for grinding cement clinker is described therein. The fly ash is ground to a Blaine fineness of at least 5000 cm²/g.

In DE 41 01 347 C2, ashes from waste incineration plants are used to produce artificial additives for the construction industry or for use in underground mining and tunnel construction. The ashes contain heavy metals, salts, etc. The ashes are mixed with cement or other organic binders with the addition of water to form agglomerates and harden. 5 to 90% by weight ash is produced with 10 to 95% by weight binder by grinding Portland cement clinker and ash together and then mixing them. There is no indication of the grain size or fineness of the incinerator bottom ash used.

In DE 38 09 938 A1, moldings are produced by pressing a water-containing mixture of fly ash and cement. The mixture contains 30 to 70% by weight fly ash, 20 to 50% by weight cement and 0.5 to 1.5 times the weight of the cement of water. This mixture can also contain filter cake from sludge dewatering or slag from waste incineration. Waste incineration slag can be added to the mixture to be compressed at 5 to 30% by weight. There is no indication of the grain size or fineness of the incinerator bottom ash.

AT 286158 B describes a process for the production of steam-hardened molded parts made of concrete, in which, in addition to cement and water, a mixture of 35 to 70% by weight of fly ash and waste incineration slag is used as an aggregate in the total composition, of which 60 to 75% by wt. % should be incineration slag.

Furthermore, EP 2 801 559 B1 discloses a process for increasing the latent hydraulic and/or pozzolanic reactivity of materials, in particular of waste and by-products, in which a starting material is used which can also include waste incineration ash, slag and the like. The materials receive a hydrothermal treatment in an autoclave, resulting in an autoclaved product with hydraulic, latent hydraulic or pozzolanic reactivity. The starting materials should be optimized in terms of particle size and particle size distribution. More detailed information on these parameters was not given.

The invention is based on the object of providing a cement-containing binder which contains incineration ash as additives, with which, despite the added incineration ash, possesses standard-compliant strength properties and strength developments as well as improved application properties. Furthermore, the object of the invention is to provide a production process for such a cement-containing binder and a plant for carrying out the production process for the binder.

Because the incineration ash has a weight percent of 0.005 to 0.4 in the binder and a defined Blaine surface area of 1500 cm²/g to 6000 cm²/g, the stated weight percent of cement can be replaced by incineration ash, which means a significant reduction in CO₂ saving is given. It is crucial for the chemical and mineralogical reaction process for the hardening process of the building material, namely mortar or concrete, that the incinerator ash has a Blaine surface area of 1500 cm²/g to 6000 cm²/g in order to provide the desired reactivity.

The incineration ash preferably has a weight percent of 0.05 to 0.25 of the binder. A significant proportion, namely at least 5% to a maximum of 25%, of the binder is thus formed from waste incineration ash, so that there is also a corresponding CO₂ saving. A maximum weight percent of 25% allows—depending on the composition of the incinerator bottom ash—a suitable immobilization of environmentally relevant pollutants, such as heavy metals, in the hardened mortar or concrete.

In a further development, the incineration ash has a weight percent of 0.1 to 0.15 in the binder. A weight percent of 10 to 15% waste incineration ash provides a nevertheless safe immobilization of any environmentally relevant pollutants contained in the waste incineration ash with a further relevant CO₂ saving.

Depending on the origin and thus the individual composition of the incinerator ash, the incinerator ash is to be regarded as a more or less latent hydraulic component, similar to the well-known use of blast furnace slag.

High levels of free lime from the Portland cement clinker or waste incineration ash component lead to the formation of Ca(OH)₂ during hydration as a stimulator for the hardening process in mortar or concrete. It is therefore important for the chemical and mineralogical reaction process to adapt the specific surface area of the incineration ash to the specific surface area of the cement in the cementitious binder according to the invention. Correspondingly, the incineration bottom ash preferably has a defined Blaine surface area of 2500 cm²/g to 5000 cm²/g.

In order to further improve the reactivity of the binder with the incinerator bottom ash additive, the incinerator bottom ash has a defined Blaine surface area of 4000 cm²/g to 4800 cm²/g.

In a further development, the binder can contain the additives blast furnace slag, blast furnace slag semolina and/or ground blast furnace slag. Known additives are thus processed in the binder in cement production for so-called Portland smelter cements or blast furnace cements, which also leads to a CO₂ saving compared to the use of a binder made exclusively of Portland cement.

If the cement is a Portland cement, a Portland slag cement, a blast furnace cement and/or a slag-containing binder, additional additives, namely cements with the short designations CEM II and/or CEM III, are already used and mixed with the incineration ash. This achieves high CO₂ savings compared to using a binder made exclusively of Portland cement and high reactivity of the binder, i.e. high final strength and cohesion.

For the production process according to the invention of a binder for building materials consisting of cement and mineral additives, the additives containing incinerator ash, the proper comminution of the incinerator ash with the best possible separation of ferrous and non-ferrous metals is important in order to obtain an additive suitable as a building material for the cement for the production of mortar or concrete. This is achieved according to the process steps according to claim 8. It is alternatively possible that the prepared waste incineration ash is added to the cement as an additive before and/or after the last comminution or grinding process. In the first alternative, the additive is fed together with the cement, for example in a ball mill, to a final joint grinding process in which the two components are also mixed at the same time. In the second alternative, the ready-to-use comminuted additive is mixed into the likewise ready-to-use cement, in particular in a mixer.

Because the pre-crushed incinerator ash, largely freed from metals, is screened after further comminution, undesired components from the incinerator ash, in particular metals, can be removed even more extensively for the building material use of the binder in concrete or mortar. If the steps for preparing and crushing the incinerator bottom ash are carried out several times in succession before mixing it into the cement, both the separation of ferrous and non-ferrous metals can be optimized and the desired fineness of the incinerator bottom ash particles can be achieved. A cascaded process further improves the quality of the mineral additives from the incinerator bottom ash.

The arrangement of processing stages known in the recycling industry in the working direction of the binder to be produced according to claim 11 enables the production of an incinerator ash with the required fineness and the separation of ferrous and non-ferrous metals as undesirable components.

The fact that a mixer for mixing the prepared waste incineration ash into the cement is arranged in the working direction behind the material bed crusher or smooth roll crusher makes it possible to create the binder consisting of cement and the prepared waste incineration ash with the desired weight proportions in a homogeneous mixture.

In a further preferred embodiment of the plant for the production of the binder a ball mill for further crushing of the crushed waste incineration ash, largely freed from metals, is arranged in the working direction after the material bed or smooth roll crusher in order to achieve a defined Blaine surface of up to 6000 cm²/g.

If a circular vibrating screen is installed in the working direction after the material bed crusher or smooth roll crusher but before the ball mill, the smooth roll crusher can be used to separate metals from the deformed laminate with high separation accuracy.

If an air sifter is also arranged after the circular vibrating screen in the working direction, the quality of the separation and thus the usability of the incinerator bottom ash prepared in this way as a mineral additive in the binder with a possibly higher weight percent of up to 0.4 can be made possible, since any components that may affect the building material damaging quality can be even more reliably removed from the resulting binder.

Eight formulations for a binder according to the invention are described below with associated tables. Two tables are listed for each formulation, the first table lists the components of the binder used, once without incinerator ash and with 0.05, 0.10, 0.15 and/or even 0.31 weight percent of incinerator ash. The second table in each case lists the respective test results for the parameters of compressive strength after 2 days, 7 days and 28 days and for formulations 7 and 8 after 56 days and for formulations 5 and 6 the water requirement and the start of setting in minutes.

In the eight formulations presented below, a corresponding binder without incinerator ash and with different proportions of incinerator ash is listed. The 13 exemplary embodiments according to the invention relate to formulations for the use of waste incineration ash with a defined Blaine specific surface area in Portland slag cement (CEM II) and blast furnace cement (CEM III) with ash/slag addition amounts of 5% by weight, 10% by weight, 15% and 31% by weight, respectively. The incinerator ashes with an initial grain size of 0-8 mm were dried in the laboratory at 120° C. The fines <1 mm were then separated from the original grain size. Only for formulations 7 and 8 was incinerated ash with a grain size of 0-40 mm used. For formulations 1 to 4 and 7 and 8, the grain fraction was reduced in a laboratory mill to a Blaine specific surface area of on average 4300 cm²/g, for formulation 5 to 6000 cm²/g and for formulation 6 to 1600 cm²/g and the formulations prepared according to the information. With the binders formulated in this way, mortar test specimens (4 cm×4 cm×16 cm prisms) were produced according to DIN EN 196 et seq. and important cement properties such as compressive strength and setting behavior were tested. These mortar test specimens are made from cement mortar, which is mixed from the binder described here, a sand fraction and water. For the sand fraction according to DIN EN 196-1, a standard sand is used with grain sizes between 0.08 and 2.00 mm (0/2). The maximum moisture content of this sand is 0.2%. For the production of 3 mortar prisms (each one has the dimensions 4 cm×4 cm×16 cm), 450 grams of the binder according to the application and 225 grams of water (water-cement ratio 0.5) and 1350 grams of this standard sand are used.

Formulation 1 shows the example of a blast furnace cement without the addition of incinerator ash (IR ash) as well as with the addition of 5% by weight and 15% by weight IR ash, each with a Blaine specific surface area of 4200-4400 cm²/g, whereby the respective proportions by weight of IR ash were divided in half between Portland cement clinker and blast furnace slag in the formulation. With regard to the results of the compressive strengths after 2, 7 and 28 days, it should be noted that although they are lower in comparison to the blast furnace cement that has not been mixed with ash, they are still sufficient for the production of a standardized CEM III cement of the compressive strength class 32.5. The processing times, recognizable at the start of solidification, have increased significantly with the increase in the amount of IR ash, which leads to improved flow behavior and a longer and more advantageous processing time. The prisms in the illustration show a dense, compact structure inside and are also without any abnormalities beyond the 28-day storage period. There is no swelling and no crack formation on the surfaces and inside the test specimens.

Exemplary embodiment Formulation 1 blast furnace cement (BFC) without the addition of IR ash and with the addition of 5% by weight and 15% by weight IR ash, each with a Blaine specific surface area of 4200-4400 cm 2/g, the respective weight proportions of IR ash were introduced into the formulation in equal parts for Portland cement clinker and blast furnace slag.

| | Components of blast furnace cement (BFC) | | |
|---|---|---|---|
| | BFC without | BFC with 5 | BFC with 15 |
| | IR ash | wt. % IR ash | wt. % IR ash |
| Portland cement clinker | 58 | 55.5 | 50.5 |
| (% by weight) | | | |
| Blast furnace slag (wt. %) | 38 | 35.5 | 30.5 |
| Anhydrite (wt. %) | 4 | 4 | 4 |
| IR ash (4200-4400 cm²/g | 0 | 5 | 15 |
| according to Blaine) | | | |

Test results on mortar samples according to EN 196 ff. for binders according to Formulation 1

| | Parameter blast furnace cement (BFC) | | |
|---|---|---|---|
| | BFC without | BFC with 5 | BFC with 15 |
| | IR ash | wt. % IR ash | wt. % IR ash |
| Compressive strength | 16.7-17.3 | 13.8 | 11.0 |
| after 2 d (MPa) | | | |
| Compressive strength | 31.9-33.2 | 28.7 | 22.2 |
| after 7 d (MPa) | | | |
| Compressive strength | 51.3-54.8 | 47.1 | 40.3 |
| after 28 d (MPa) | | | |
| Start of | 240 | 295 | 485 |
| solidification (min) | | | |

Formulation 2 shows the example of a Portland slag cement without the addition of incinerator ash (JR ash) and with the addition of 5% by weight and 15% by weight JR ash, each with a Blaine specific surface area of 4200-4400 cm²/g, whereby the respective proportions by weight of RDF ash were divided in half between Portland cement clinker and blast furnace slag in the formulation. For the results of the compressive strengths after 2, 7 and 28 days, it should be noted that although they are lower in comparison to Portland slag cement that has not been mixed with ash, they are still sufficient for the production of a standardized CEM II cement of the compressive strength class 32.5, as long as the addition of the IR ash remains at just under 5% by weight. The processing times, recognizable at the start of solidification, have increased significantly with the increase in the amount of IR ash, which also leads to improved flow behavior and a longer processing time in this case. The prisms in the illustration show a dense, compact structure internally and are also without any abnormalities beyond the 28-day storage period. There is no swelling and no crack formation on the surfaces or inside the test specimens.

Exemplary embodiment Formulation 2 Portland slag cement (PSC) without the addition of IR ash and with the addition of 5% by weight and 15% by weight IR ash, each with a Blaine specific surface area of 4200-4400 cm 2/g, the respective Weight proportions of IR ash were introduced into the formulation in equal parts for Portland cement clinker and blast furnace slag.

| | Constituents Portland slag cement (PSC) | | |
|---|---|---|---|
| | PSC without | PSC with 5 | PSC with 15 |
| | IR ash | wt. % IR ash | wt. % IR ash |
| Portland cement | 66 | 63.5 | 58.5 |
| clinker (% by weight) | | | |
| Blast furnace slag (wt. %) | 31 | 28.5 | 23.5 |
| Anhydrite (wt. %) | 3 | 3 | 3 |
| IR ash (4200-4400 cm²/ | 0 | 5 | 15 |
| g according to Blaine) | | | |

Test results on mortar samples according to EN 196 ff. for binders according to Formulation 2

| | Parameter Portland slag cement (PSC) | | |
|---|---|---|---|
| | PSC without | PSC with 5 | PSC with 15 |
| | IR ash | wt. % IR ash | wt. % IR ash |
| Compressive strength | 14:3-16 | 12.0 | 8.2 |
| after 2 d (MPa) | | | |
| Compressive strength | 26.5-34.5 | 24.0 | 18.6 |
| after 7 d (MPa) | | | |
| Compressive strength | 44.1-55.1 | 38.9 | 27.4 |
| after 28 d (MPa) | | | |
| Start of | 190 | 225 | 350 |
| solidification (min) | | | |

Formulation 3 shows the example of a blast furnace cement without the addition of incinerator ash (IR ash) and with the addition of 5% by weight and 15% by weight IR ash, each with a Blaine specific surface area of 4200-4400 cm²/g, whereby the respective proportions by weight of IR ash were only introduced in the formulation proportionately against blast furnace slag. The amount of Portland cement clinker, on the other hand, remains in the original amount. For the results of the compressive strengths after 2, 7 and 28 days, it can be stated that all mixtures are sufficient for the production of a standardized CEM III cement of the compressive strength class 32.5. Since the Portland cement clinker component, which is essential for the compressive strength, has not been changed, the compressive strengths are significantly better. The processing times, recognizable at the start of solidification, have increased significantly with the increase in the amount of IR ash, which in turn leads to improved flow behavior and a longer processing time in this case.

Exemplary embodiment Formulation 3 blast furnace cement (BFC) without the addition of IR ash and with the addition of 5% by weight and 15% by weight IR ash, each with a Blaine specific surface area of 4200-4400 cm²/g, wherein the respective weight proportions of IR ash were only introduced proportionately against blast furnace slag in the formulation. The amount of Portland cement clinker remains in the original amount.

| | Components of blast furnace cement (BFC) | | |
|---|---|---|---|
| | BFC without | BFC with 5 | BFC with 15 |
| | IR ash | wt. % IR ash | wt. % IR ash |
| Portland cement | 58 | 58 | 58 |
| clinker (% by weight) | | | |
| blast furnace slag | 38 | 33 | 23 |
| (wt. %) | | | |
| Anhydrite (wt. %) | 4 | 4 | 4 |
| IR ash (4200-4400 cm²/ | 0 | 5 | 15 |
| g according to Blaine) | | | |

Test results on mortar samples according to EN 196 ff. for binders according to Formulation 3

| | Parameter blast furnace cement (BFC) | | |
|---|---|---|---|
| | BFC without | BFC with 5 | BFC with 15 |
| | IR ash | wt. % IR ash | wt. % IR ash |
| Compressive strength | 16.7-17.3 | 16.3 | 14.8 |
| after 2 d (MPa) | | | |
| Compressive strength | 31.9-33.2 | 32:1 | 28.3 |
| after 7 d (MPa) | | | |
| Compressive strength | 51.3-54.8 | 53.7 | 45.5 |
| after 28 d (MPa) | | | |
| Start of | 255 | 255 | 330 |
| solidification (min) | | | |

Formulation 4 shows the example of a Portland slag cement without the addition of incinerator ash (JR ash) and with the addition of 5% by weight and 15% by weight JR ash, each with a Blaine specific surface area of 4200-4400 cm²/g, whereby the respective proportions by weight of IR ash were only introduced in the formulation proportionately against blast furnace slag. The amount of Portland cement clinker, on the other hand, remains in the original amount. For the results of the compressive strengths after 2, 7 and 28 days, it can be stated that all mixtures are sufficient for the production of a standardized CEM II cement of the compressive strength class 32.5. Since the Portland cement clinker component, which is essential for the compressive strength, was not changed, the compressive strengths are significantly better and, for the addition of 5% by weight of IR ash, comparable to Portland slag cement without the addition of IR ash. At the early strength level of 2 days, a slight increase of over 1 MPa can even be seen. The processing times, recognizable at the start of solidification, have increased significantly with the increase in the amount of IR ash, which in turn leads to improved flow behavior and a longer processing time in this case.

Exemplary embodiment Formulation 4 Portland slag cement (PSC) without the addition of IR ash and with the addition of 5% by weight and 15% by weight IR ash, each with a Blaine specific surface area of 4200-4400 cm²/g, the respective weight proportions of IR ash were only introduced proportionately against blast furnace slag in the formulation. The amount of Portland cement clinker remains in the original amount.

| | Constituents Portland slag cement (PSC) | | |
|---|---|---|---|
| | PSC without | PSC with 5 | PSC with 15 |
| | IR ash | wt. % IR ash | wt. % IR ash |
| Portland cement | 66 | 66 | 66 |
| clinker (% by weight) | | | |
| blast furnace slag (wt. %) | 31 | 26 | 16 |
| Anhydrite (wt. %) | 3 | 3 | 3 |
| IR ash (4200-4400 cm2/ | 0 | 5 | 15 |
| g according to Blaine) | | | |

Test results on mortar samples according to EN 196 ff. for binders according to Formulation 4

| | Parameter Portland slag cement (PSC) | | |
|---|---|---|---|
| | PSC without | PSC with 5 | PSC with 15 |
| | IR ash | wt. % IR ash | wt. % IR ash |
| Compressive strength after | 14:3-16 | 17.2 | 13.7 |
| 2 d (MPa) | | | |
| Compressive strength after | 26.5-34.5 | 31.0 | 25.7 |
| 7 d (MPa) | | | |
| Compressive strength after | 44.1-55.1 | 48.9 | 40.3 |
| 28 d (MPa) | | | |
| Start of solidification (min) | 210 | 255 | 305 |

Formulation 5 shows an example of a blast furnace cement (BFC) CEM III/A with an addition of 15 wt. % waste incineration bottom ash with a specific Blaine surface area of 6000 cm2/g, with the proportion by weight of IR being included in the formulation in relation to blast furnace slag.

| | Components of blast furnace cement (BFC) | |
|---|---|---|
| | BFC without | BFC with 15 |
| | IR ash | wt. % IR ash |
| Portland cement | 58 | 58 |
| clinker (% by weight) | | |
| Blast furnace slag (wt. %) | 38 | 23 |
| Anhydrite (wt. %) | 4 | 4 |
| IR Ash (6000 cm²/ | 0 | 15 |
| g Blaine) | | |

Test results on mortar samples according to EN 196 ff. for binders according to Formulation 5

Parameter blast furnace cement (BFC)

| | BFC without | BFC with 15 |
|---|---|---|
| | IR ash | wt. % IR ash |
| Compressive strength | 16.9 | 11.6 |
| after 2 d (MPa) | | |
| Compressive strength | 28.4 | 20.8 |
| after 7 d (MPa) | | |
| Compressive strength | 49.1 | 32.4 |
| after 28 d (MPa) | | |
| Water requirement (% | 26 | 26.5 |
| by weight) | | |
| Start of | 180 | 720 |
| solidification (min) | | |

The test results on mortar samples according to EN 196 ff. showed satisfactory compressive strength. Although they are lower than the “zero cement” (without IR additive in the formulation), the 28d compressive strength of 32.4 MPa is directly at the standard limit for a BFC CEM III/A 32.5. In addition, the water requirement in the formulations was determined. Despite the high grinding fineness of 6000 cm²/g for the incinerator, only a very small increase from 26% for the “zero cement” to 26.5% for the cement mixed with incinerator was found. An increase in the specific fineness of grinding according to Blaine to 6000 cm²/g for the incinerator does not lead to a significant increase in the water requirement. This is a very good result with regard to a later application of the binder in the concrete, should a higher fineness of grind be desired for the incinerator. If, for example, the Portland cement clinker component were to be ground to such a high degree of fineness, significantly higher water requirements would be expected, which would immediately have a negative impact on the concrete compressive strength.

The processing time increases significantly from 180 minutes for the “zero cement” to 720 minutes for the cement mixed with IR.

Formulation 6 shows an example of a Portland granulated cement (PSC) with an addition of 31% by weight IR with a Blaine specific surface area of 1600 cm²/g, the proportion by weight of the IR being completely replaced by blast furnace slag in the formulation. In addition, in a further formulation, 15% by weight of slag sand was replaced by JR with a Blaine specific surface area of 1600 cm²/g.

| | Constituents Portland slag cement (PSC) | | |
|---|---|---|---|
| | PSC without | PSC with 31 | PSC with 15 |
| | IR ash | wt. % IR ash | wt. % IR ash |
| Portland cement | 66 | 66 | 66 |
| clinker (% by weight) | | | |
| Blast furnace slag (wt. %) | 31 | 0 | 16 |
| Anhydrite (wt. %) | 3 | 3 | 3 |
| IR ash (1600 cm²/ | 0 | 31 | 15 |
| g according to Blaine) | | | |

Test results on mortar samples according to EN 196 ff. for binders according to Formulation 6

| | Parameter Portland slag cement (PSC) | | |
|---|---|---|---|
| | PSC without | PSC with 31 | PSC with 15 |
| | IR ash | wt. % IR ash | wt. % IR ash |
| Compressive strength after | 15.4 | 7 | 10 |
| 2 d (MPa) | | | |
| Compressive strength after | 28.7 | 13.1 | 16.2 |
| 7 d (MPa) | | | |
| Compressive strength after | 48.7 | 16.5 | 24 |
| 28 d (MPa) | | | |
| Water requirement (% by | 25 | 29.5 | 29.5 |
| weight) | | | |
| Start of solidification (min) | 215 | 795 | 560 |

The test results on mortar samples according to EN 196 et seq. showed significantly lower compressive strengths compared to “zero cement”. The early strength values were only half as high. The generally lower compressive strengths are due to the complete replacement of blast furnace slag by the incinerator bottom ash for this type of binder. In addition, the water requirement increases significantly from 25% for the “zero cement” to 29.5% for the cement mixed with waste incinerators.

The processing time also increases sharply from 215 minutes to 795 minutes.

However, the ratios improve if only 15% by weight of IR instead of 31% by weight of IR are used in the formulation. This is shown by the exemplary embodiment of Formulation 7.

Portland cement (PSC) example Formulation 6 (last column): addition of 15 wt. %. IR with a Blaine specific surface area of 1600 cm²/g, whereby the proportion by weight of the IR was introduced into the recipe in relation to blast furnace slag. The compressive strengths improve significantly compared to the results with complete replacement of the blast furnace slag by incinerator slag. The processing time is also slightly shorter at 560 minutes, but the water requirement does not change.

Accordingly, the amount of IR added to the binders examined should ideally not exceed a value of 15% by weight in order to achieve acceptable compressive strength and processing times. For the production of special application-related binders such as landfill binders, higher incinerator inputs in the formulations are also conceivable. These examples should then be checked for possible uses in each individual case.

For a binder based on PSC, a specific Blaine fineness of 2000-3000 cm²/g could also be sufficient for the incinerator in order to obtain acceptable compressive strengths. However, Blaine values of around 1600 cm²/g could also work here, depending on the intended use of the binder, for example with soil mortar and/or landfill binders.

For the tests with BFC in particular, an addition of 15 wt. % IR as shown in previous tests, a Blaine specific grinding fineness of 4300 cm²/g of the IR is sufficient to achieve acceptable compressive strengths. A further increase in the grinding fineness to 6000 cm²/g does not result in any significant improvement in the compressive strength.

The following exemplary embodiments were carried out on an initial grain size of 0-40 mm of IR from the waste incineration plant. The IR was ground to a specific Blaine fineness of 4300 cm²/g. In addition to the standard compressive strengths of up to 28d, the 56d compressive strength should also be determined this time. It was necessary to check whether there would be a further increase in strength, which would also allow conclusions to be drawn about pozzolanic (similar to fly ash) or latent hydraulic (similar to blast furnace slag) activity of the IR ash.

Two binders were made.

Formulation 7 shows an illustrative example of a blast furnace cement (BFC) without the addition of IR ash and with an addition of 10 wt. % with a Blane specific surface area of 4300 cm²/g. The amount of Portland cement clinker remained in the original amount, wherein the proportions by weight of IR were only included in the formulation proportionately against blast furnace slag. The amount of Portland cement clinker remained in the original amount.

With these formulations, the compressive strength test should be extended to 56 days.

| | Components of blast furnace cement (BFC) | |
|---|---|---|
| | BFC without | BFC with 10 |
| | IR ash | wt. % IR ash |
| Portland cement | 58 | 58 |
| clinker (wt. %) | | |
| Blast furnace slag (wt. %) | 38 | 28 |
| Anhydrite (wt. %) | 4 | 4 |
| IR Ash (4300 cm²/ | 0 | 10 |
| g Blaine) | | |

Test results on mortar samples according to EN 196 ff. for binders according to Formulation 7

Parameter blast furnace cement (BFC)

| | BFC without | BFC with 10 |
|---|---|---|
| | IR ash | wt. % IR ash |
| Compressive strength | 19.2 | 14.5 |
| after 2 d (MPa) | | |
| Compressive strength | 33.1 | 27.1 |
| after 7 d (MPa) | | |
| Compressive strength | 57.3 | 39 |
| after 28 d (MPa) | | |
| Compressive strength | 65.6 | 53.2 |
| after 56 d (MPa) | | |
| Start of | 155 | 310 |
| solidification (min) | | |

Results Example 7: The compressive strengths are generally somewhat lower compared to the “zero cement”, but there is a potential for an increase beyond the period of 28 days. The compressive strength increases from 39 MPa after 28 days to 53.2 MPa after 56 days, an increase of around 35%. However, there is another positive feature. While the increase from 28d to 56d in the “zero cement” is only around 15%, we have at least twice as much increase in the binder made with incinerator and blast furnace slag. This could be an indication of an additional reactive component in the incinerator, which additionally reacts together with the blast furnace slag component in the binder. Together with the result from Formulation 8 (see below), this would be a first indication that the higher the proportion of blast furnace slag in the binder with the same amount of IR ash added, the more reactive the final strength development in the strength period under consideration.

The processing times are slightly longer compared to “zero cement” (this is known), but are within the usual normal range. The water requirement is about 1.5% higher.

Formulation 8 shows an example of a Portland slag cement (PSC) without the addition of IR ash and with an addition of 10 wt. % IR with a Blane specific surface area of 4300 cm²/g, wherein the proportions by weight of IR were only included in the formulation proportionately against blast furnace slag. The amount of Portland cement clinker remained in the original amount.

| | Constituents Portland slag cement (PSC) | |
|---|---|---|
| | PSC without | PSC with 10 |
| | IR ash | wt. % IR ash |
| Portland cement | 66 | 66 |
| clinker (% by weight) | | |
| Blast furnace slag (wt. %) | 31 | 21 |
| Anhydrite (wt. %) | 3 | 3 |
| IR Ash (4300 cm2/ | 0 | 10 |
| g Blaine) | | |

Test results on mortar samples according to EN 196 ff. for binders according to Formulation 8

| | Parameter Portland slag cement (PSC) | |
|---|---|---|
| | PSC without | PSC with 10 |
| | IR ash | wt. % IR ash |
| Compressive strength after | 18.3 | 11.8 |
| 2 d (MPa) | | |
| Compressive strength after | 32.7 | 23.4 |
| 7 d (MPa) | | |
| Compressive strength after | 50.3 | 36.1 |
| 28 d (MPa) | | |
| Compressive strength after | 62.6 | 43 |
| 56 d (MPa) | | |
| Start of solidification (min) | 205 | 370 |

Results Formulation 8: Compared to the “zero cement”, the compressive strengths are clearly lower when using the IR, but there is also a reasonable potential for increase in this binder, which can be seen in the 56d value. Since there was an increase from 28d to 56d with almost 20% increase (from 36.1 MPa to 43 MPa), the question arises here as to whether this was caused by additional reactivity of the IR. If you look at the increase for the “zero cement” for the test period (from 50.3 MPa to 62.6 MPa), we have an increase of approx. 22%. It can be assumed that the additional effect for the 56d in this case was probably caused somewhat more strongly by the blast furnace slag content. But 10% of the blast furnace slag was replaced by IR and the rate of increase in strength from 28d to 56d was not negatively affected. A difference of 2% in the results is also still in the error tolerance of the compressive strength determination.

The processing time is slightly longer than that of “zero cement” (this is known), but is within the normal range. The water requirement for this binder is only 0.5% higher.

A cementitious binder according to the invention can be produced using conventional mixing systems, for example using a mixing system for mixing Portland cement and ground granulated blast furnace slag to produce a Portland slag cement or blast furnace cement as “pre-cement”, in which the IR ash with a defined specific Blaine surface is then metered in.

Alternatively, conventional grinding equipment can be used to produce fine or ultra-fine cements. In this, for example, Portland cement clinker can be pre-ground to a clinker powder and finish-ground together with an IR ash with a defined Blaine specific surface area and a finely divided setting regulator (e.g. gypsum and/or anhydrite), for example in a continuous ball mill. With this ball mill, the IR ash can also be pre-ground to a defined Blaine specific surface area and then mixed with the above-mentioned “pre-cement” via a mixing plant, the cement-containing binder according to the invention can also be produced with a two-stage grinding plant for Portland cements consisting of a high-pressure roller mill, which is followed by a ball mill as a continuous mill. The high-pressure roller mill grinds Portland cement clinker and blast furnace slag together, with this premix being stored in appropriate intermediate silos and conveyed from there to the ball mill. The IR ash produced to a defined Blaine specific surface area is then conveyed into the ball mill together with the “premix” and a setting regulator (gypsum and/or anhydrite) and ground to a cement or cement-containing binder according to the invention.

Waste incineration bottom ash (waste incineration slag), for example with an initial grain size of 0-8 mm, is first separated from the original grain size by sieving to remove fines <1 mm. The grain fraction, here 1-8 mm, is ground to a defined specific Blaine surface area of 4200-4400 cm²/g (on average 4300 cm²/g). A conventional grinding plant such as a ball mill for the production of fine or ultra-fine cements can be used for this purpose. Alternatively, a two-stage grinding plant, which consists of a high-pressure roller mill with a downstream ball mill, can also be used. Waste incineration bottom ash with a grain size >8 mm can be pre-crushed on the high pressure roller mill and finally ground in a downstream ball mill. Depending on the result of the chemical and mineralogical analysis, the resulting fine fraction <1 mm can either be separated or used for further grinding to a defined Blaine specific surface area for further processing. The separation depends on the presence of environmentally relevant pollutants such as heavy metals, depending on the subsequent use of the cementitious binder according to the invention. The binder can be used, for example, as a landfill binder, for the production of concrete and concrete products, such as paving stones, or masonry mortar. For example, for 1 m³ of normal concrete with a density of 2400 kg/m3 and a water/cement ratio of 0.5, 480 kg of the binder according to the invention, 1920 kg of gravel and 240 l of water are used. The mixing ratio of gravel and the binder described here should be around 4:1 to achieve an average strength class of C20/25, i.e. 4 units of gravel, 1 unit of the binder and 0.5 unit of water. Of course, depending on the type and intended use of the concrete to be produced, the amount of binder to be used must be adjusted. Furthermore, an exemplary embodiment of a system for carrying out the production process for the binder is described in detail with reference to the attached FIGURE.

There is shown in:

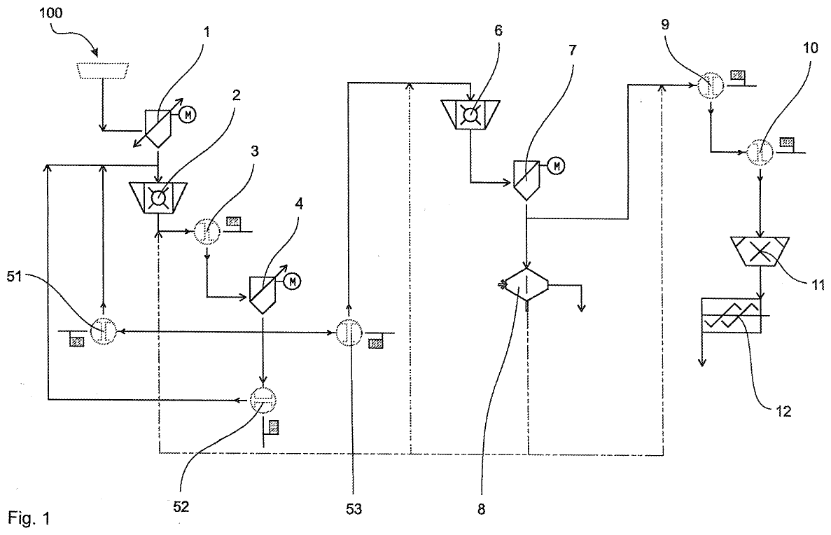

FIG. 1 a flow chart with the system components in a schematic view.

FIG. 1 shows a flow chart for the manufacturing process of a binder for building materials comprising cement and mineral additives, the additives containing waste incineration ash. The starting material is conventionally processed dry IR slag (incineration ash) 100 with a grain size of 0-40 mm and freed from metals and unburned materials according to the state of the art. Depending on the moisture content of the material, drying e.g. with a drying drum may be necessary for optimal screening results.

The material is first freed from material larger than approx. 40 mm and smaller than approx. 1 mm with a combined double-deck screen, a first 3D flip-flow screen 1 with a flip-flop in the lower screen.

The materials that are screened out initially no longer play a role in the process considered here. Depending on the quality of the end product that is actually produced, the screen sections of the fractions to be separated out can be adjusted with regard to the goal of producing the greatest possible quantity of finished material in a defined quality.

The material between about 1 and 40 mm is crushed or, as far as the metals are concerned, opened up, i.e. freed from adhesions and caking using vertical crusher 2; especially in material-friendly processing with e.g. a ball roll crusher, cone crusher or basin crusher.

Thereafter, iron is separated by means of a suitable first iron separator 3, in particular one or more over-belt magnets.

This is followed by further screening using a triple-deck screen, a second 3D flip-flow screen 4. In the upper deck, a square mesh or a 3D screen of approx. 10 mm is used to separate out oversize particles, mainly metals—and there in particular V2A. This material is processed in a separate process and the slag content is preferably fed back into production.

The grain sizes of approx. 0-2 mm, approx. 2-5 mm and approx. 5-10 mm produced via flip-wave screening are run in parallel to three non-ferrous separators 51, 52, 53 to separate other metals. It may be necessary to cascade the non-ferrous separator and use two non-ferrous separators for each particle size range. The screen cuts used are optimized according to the grading curve that actually occurs during the crushing process, i.e. shifted in such a way that the non-ferrous separators achieve optimal utilization with regard to the target of maximum throughput with the setting of a defined maximum metal content.

The grain sizes from the first non-ferrous separators 51 and second non-ferrous separators 52 of, for example, 2-10 mm, which have been brought together again, are fed back to the vertical crusher 2. The fine material, currently 0-2 mm, from the third non-ferrous separator 53 is fed into a roll crusher 6.

Alternatively, the granules can also be brought together from all three non-ferrous separators 51, 52, 53 and fed to the roll crusher 6. Two roll crushers can also be arranged one behind the other, with the input material being pre-crushed in a first roll crusher and then broken down to a first final fineness in the second roll crusher. In addition, the solid residual metals are plated here. In this alternative design, it may be necessary to provide a suitable screening, e.g. with a circular vibrator with, for example, 2 mm sieving.

The processing with a circular vibrating screen 7 will take place with the finest possible screen cut (assumed here 0.6 mm) due to the nature of the material.

The coarse-grained material from this screening is in the best case discharged from the process, because it contains sufficient metal, or is processed using a suitable wind classifier 8 (e.g. zigzag classifier or separating table) with the aim of discharging metals. If necessary, the processed material is inserted before the first non-ferrous separator 3, before the roll crusher 6 or before a second non-ferrous separator 9.

The need for a second non-ferrous separator 9 for non-ferrous separation and a fourth non-ferrous separator 10 for non-ferrous separation depends on the need for further metal removal resulting from the material composition of the heterogeneous waste incineration ash (starting material) 100.

At this point in the production process, a cut could take place such that the material produced, namely the processed incinerator bottom ash, is either loaded and taken to a cement plant as input material, or is further processed on site.

In both cases, a ball mill 11 is used to produce the cement aggregate in the desired fineness.

When the material is delivered for processing in the ball mill 11 of the cement works, it is continuously added according to the formulation into the material flow provided for the grinding process directly in front of the ball mill 11 and the material is mixed with cement in a mixer 12.

In the case of delivery of the end product to the cement works, the dosed admixture takes place as part of the manufacture of the end product using a mixer 12.

### REFERENCE LIST

100 incinerator ash (feedstock)
1 first 3D/flip-flow screen
2 vertical crushers
3 first non-ferrous separator
4 second 3D/flip-flow screen
51 first non-ferrous separator
52 second non-ferrous separator
53 third non-ferrous separator
6 roller crusher
7 circular vibrating screen
8 air classifier
9 second non-ferrous separator
10 fourth non-ferrous separator
11 ball mill
12 mixer

1. A binder for building materials comprising cement and mineral additives, the additives containing incinerator ash, wherein the incinerator ash in the binder has a weight percent of 0.005 to 0.4 and a defined Blaine surface area of 1500 cm²/g to 6000 cm²/g.

2. The binder according to claim 1, wherein the incinerator ash has a weight percent of 0.05 to 0.25 in the binder.

3. The binder according to claim 2, wherein the incinerator ash has a weight percent of 0.1 to 0.15 in the binder.

4. The binder according to claim 1, wherein the incinerator ash has a defined Blaine surface area of 2500 cm²/g to 5000 cm²/g.

5. The binder according to claim 4, wherein the incinerator ash has a defined Blaine surface area of 4000 cm²/g to 4800 cm²/g.

6. The binder according to claim 1 wherein the additives contain at least one of blast furnace slag, blast furnace slag semolina and ground blast furnace slag.

7. The binder according to claim 1, wherein the cement is at least one of a Portland cement, a Portland slag cement, a blast furnace cement and a slag-containing binder.

8. A process for producing a binder for building materials comprising cement and mineral additives, the additives containing waste incinerator bottom ash, comprising the steps
preparing the incinerator bottom ash intended as additive by separating the fraction smaller than 1 mm in size and the coarse grain larger than 40 mm in size;
pre-crushing the incinerator bottom ash freed from undersize and oversize;
separating ferrous and non-ferrous metals;
further crushing of the pre-crushed waste incineration bottom ash, which has been subject to separating of ferrous and non-ferrous metals, in order to achieve a defined Blaine surface area of 1500 cm²/g to 6000 cm²/g;
wherein before and/or after the further crushing of the pre-shredded waste incineration bottom ash that has been largely freed from metals, the waste incineration ash prepared in this way is mixed into the cement.

9. The process according to claim 8, wherein after further crushing, the pre-comminuted waste incineration ash, which has been subject to separating of ferrous and non-ferrous metals, is screened.

10. The process according to claim 8, wherein the steps for preparing and crushing the incinerator ash are carried out several times in succession before mixing it into the cement.

11. A plant for carrying out the process according to claim 8, in which the following are arranged one after the other in the working direction of the plant:
a flip-flop screening machine (1) for preparing the incinerator bottom ash (100) intended as additive by separating the fraction smaller than 1 mm in size and the coarse grain larger than 40 mm in size,
a vertical crusher (2) for pre-crushing the incinerator bottom ash (100) freed from undersize and coarse grain,
an overbelt magnetic separator, magnetic rollers and/or drum magnets for separating ferrous metals;
an eddy current separation for separating non-ferrous metals; and
a material bed crusher or smooth roll crusher (6) for further crushing of the pre-comminuted waste incineration bottom ash (100) which has been subject to separating of ferrous and non-ferrous metals, in order to achieve a defined Blaine surface area of greater than 1500 cm²/g.

12. The plant according to claim 11, wherein a mixer (12) for mixing the waste incineration ash (100) prepared in this way into the cement is arranged in the working direction behind the material bed crusher or smooth roll crusher (6).

13. The plant according to claim 11, wherein a ball mill (11) for further comminuting the comminuted waste incineration bottom ash (100) which has been subject to separating of ferrous and non-ferrous metals is arranged downstream of the material bed or smooth roll crusher (6) in the working direction, in order to achieve a defined surface according to Blaine of up to 6000 cm²/g.

14. The plant according to claim 13, wherein a circular vibrating screen (7) is arranged in the working direction after the material bed or smooth roll crusher (6) but before the ball mill (11).

15. The plant according to claim 14, wherein an air classifier (8) is additionally arranged in the working direction after the circular vibrating screen (7).
